(19) United States
(12) Patent Application Publication
(10) Pub. No.: US 2007/0046214 A1
(43) Pub. Date: Mar. 1, 2007

(54) Apparatus comprising an array of switches and display

(76) Inventor: Nicholas F. Pasch, Pacifica, CA (US)

Correspondence Address: Trellis Intellectual Property Law Group, PC, 1900 EMBARCADERO ROAD, SUITE 109, PALO ALTO, CA, 94303, US

(21) Appl. No.: 11/485,539

(22) Filed: Jul. 11, 2006

Related U.S. Application Data
(60) Provisional application No. 60/711,741, filed on Aug. 26, 2005.

(51) Int. Cl. G09G 3/10

(52) U.S. Cl. 315/169.3

(57) ABSTRACT

A class of electromechanical switch cell is disclosed that has improved switching speed and tolerance to array non-planarity, among other advantages. In one embodiment, the switch cell can include a movable foil that is anchored to the structure, but is not under tension in the unbiased state. In another embodiment, a flexible foil may be mechanically biased so that a portion of the foil is positioned proximate to a reference substrate.

### REFERENCE TO RELATED APPLICATIONS

This application claims the benefit of U.S. Provisional Application No. 60/711,741, filed Aug. 26, 2005 (Attorney Docket No. 100115-001200US), which is incorporated herein by reference in its entirety.

### BACKGROUND OF THE INVENTION

1. Field of the Invention

Embodiments of the present invention relate to a switch array. More particularly, embodiments of the present invention relate to an array of switches that may be used in various applications, such as display applications.

2. Description of the Background Art

A flexible array of micro-electromechanical switches (e.g., FASwitch™ switches) includes advantages, such as low cost and the ability to adapt the array to a variety of uses. By way of example, the array of switches can be adapted for printer applications, as a wearable display, as an annunciator, as a component of electronic paper, or as the backplane for a variety of optical displays.

Optical displays, such as liquid crystal displays (“LCDs”), plasma displays and light emitting displays (LEDs), electro-luminescent displays, electronic ink paper displays and other pixel-based displays are used in many products, such as computer displays, cellular telephones, flat screen televisions, watches, entertainment devices, microwave ovens, and many other electronic devices. Today's optical displays typically rely on a matrix of thin film transistors and (often) corresponding capacitors, deposited on a glass membrane, to control individual pixels. This transistor and capacitor matrix is often referred to as an “active matrix display backplane” or “backplane” for short. By applying a voltage to a row electrode and a column electrode, the transistor at the intersection of the row and column can control the pixel while the capacitor holds the charge until the next refresh cycle.

To reduce the cost and to provide novel capabilities associated with many display applications, FASwitch™ switches can include a class of flexible micro elecromechanical system (MEMS) devices or switch arrays that may be created from relatively inexpensive polymer foils. The switch cell design preferably uses electrostatic attraction to pull the polymer foils together to achieve an ON state and may use the elastic energy stored in the stretched polymer film to return the switch to the OFF state. The use of both mechanical and electrostatic force to change the state of the switch has many advantages, including relatively low cost drive circuitry and simple manufacturability. However, an optimal solution of the balancing of such electrostatic and mechanical forces sometimes compels a cell design with certain features, such as thin polymer foils, relatively large pixel pitch or narrow gaps between foils.

It will also be appreciated that some particular variations of FASwitch™ switch arrays may have relatively slow switching speed because of a reliance on mechanical force to return the switch to the OFF state. Further, maintaining the tolerance of the spacing between foils across the array may be difficult because a moveable membrane must be maintained under tension very close to an associated non-moveable membrane. Thus, it has been discovered that there is a great need for a switch array where the movable membrane of the switch, while anchored to the structure is not under tension and that can be rapidly switched between the ON state and the OFF state.

What is also needed is a class of flexible micro electro-mechanical switch (MEMS) devices or arrays that can maintain the many of the advantages of previous FASwitch™ switch cell designs, but that do not rely on mechanical forces to open up the switch. When mechanical force is relied upon to ensure that the switch turns off, it may be necessary that the flexible foil of the switch be under tension. This tension can assure that the flexible foil stores a predictable quantity of elastic energy, and that the mechanical pull back of the switch contacts to the OFF state will reliably take place. A consequence of the use of maintaining the flexible foil under tension may result in a limited ability to introduce non-planarity of the switch array. More specifically, as the switch array bends, the flexible foil remains planar, and it does not take a great deal of bending before the flexible foil contacts either a substrate or an encapsulation layer. Thus, the function of the switch may not be assured when the flexible foil is so displaced. Accordingly, what is needed is an improved cell design that addresses identified manufacturability or normal use constraints.

Further, what is also desired is an improved mechanism that includes an optical shutter to control light emitted through a transparent area of a mask structure. In prior applications, controlling the emission of light a transparent area of a mask structure relied on a moving occultating disk. This optical design concept was well adapted to the FASwitch™ switch array where the moveable polymer foil is maintained under tension. However, a new optical shutter principle is required where the moveable polymer foil is not maintained under tension.

Accordingly, there is a need for an apparatus that incorporates a switch array that addresses the known areas of existing switch cell technology where improvement is desired.

### BRIEF DESCRIPTION OF THE DRAWINGS

FIG. 1 is a sectional side view of an exemplary low tension cell (LTC) in accordance with embodiments of the present invention.

FIG. 2 is a sectional side view of an exemplary S-cell in accordance with embodiments of the present invention.

FIG. 3 is a sectional side view of an exemplary wave cell in accordance with embodiments of the present invention.

FIG. 4 is another sectional side view of the exemplary wave cell in accordance with embodiments of the present invention.

FIG. 5 is a sectional side view of an exemplary pinch cell structure in accordance with embodiments of the present invention.

### DETAILED DESCRIPTION OF EMBODIMENTS OF THE INVENTION

In the description herein for embodiments of the present invention, numerous specific details are provided, such as examples of components and/or methods, to provide a thorough understanding of embodiments of the present invention. However, embodiments of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

In accordance with embodiments of the present invention, an array of mechanical switches may be controlled by row/column electrodes that are accessible by drivers similar in operation to ones currently used in conventional optical displays. The array may be used to create nonlinear voltage and/or current switching responses that are applied or impressed on the optical cells of the display to generate an image. Other types of display technologies or electrical design or fabrication techniques can be used in conjunction with those specific technologies, designs or techniques described herein. For example, features of the MEM switching approach can be used with any type of actuator, switch, chemical or physical device or property, etc., to cause an effect suitable for imaging in an optical display. In general, any type of suitable driver or drive signal can be used in accordance with embodiments.

An example of a FASwitch™ switch cell where the moveable polymer foil is maintained under tension has been previously disclosed in a utility patent application entitled “MICRO-ELECTROMECHANICAL SWITCHING BACKPLANE” by Michael D. Sauvante, et al., application Ser. No. 10/959,604, filed on Oct. 5, 2004, the disclosure of which is incorporated herein for all purposes.

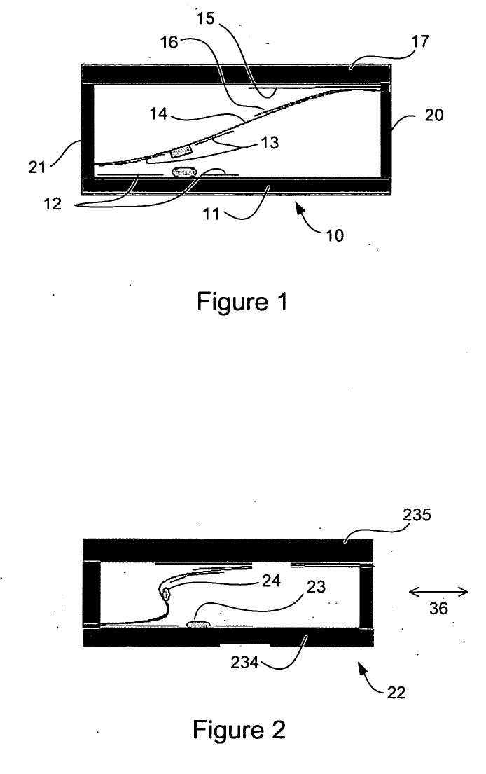

Referring now to the drawings more particularly by reference numbers, an exemplary low tension cell (LTC) and an exemplary “S-cell” in accordance with embodiments of the present invention are shown in FIGS. 1 and 2.

In one aspect of embodiments of the present invention, a class of MEMS switch cells may improve the frequency that the cells can be switched from the ON state to the OFF state. More specifically, the movable membrane of the switch may be anchored to the cell structure, but the movable membrane may not be under tension. Electrostatic attraction can be used to pull the moveable membrane into both the ON state and the OFF state position. Thus, this class of MEMS switch cells may have a significantly improved switching speed.

Because of the movable membrane of the switch not being under tension, this class of MEMS switch cells may be more tolerant of variations in manufacturing tolerances, as compared to other approaches. Specifically, the class of MEMS switch cells can be significantly less sensitive to the planarity of the substrate membrane or to the spacing between the substrate membrane and the movable membrane. Further, the class of MEMS switch cells may have a smaller pitch from one cell to another cell and thus may be significantly optimized for use in displays. Since both the substrate and the movable membrane can be made of polymer foil, the array of MEM switches is flexible, thereby enabling a wide range of possible applications.

Further, another embodiment of a class of switch cells may not store elastic energy in the flexible foil. Rather, in accordance with embodiments -of the present invention, a movable foil may be electrostatically pulled from the ON state to the OFF state, and vice versa. Advantageously, there may be no requirement for balancing the electrostatic and mechanical energies, as may be required when the flexible foil is held in tension, as discussed above. As is understood by those skilled in the art, other means of attracting the movable foil may be used in lieu of electrostatic force. For example, magnetic, magnetorestrictive, electromagnetic, or other means of generating attractive or repulsive forces may be used in accordance with embodiments of the present invention.

Because this class of switch cell designs may not require separate drive electronics for pulling the movable foil into either the ON state or the OFF state, the amount of power needed for the switch transition can be much reduced, as compared to other approaches. Specifically, in accordance with embodiments of the present invention, there may be no need to apply a holding force to the switch to oppose the mechanical force created when the flexible foil is in the ON state. This power reduction can be used either to reduce the total power of the switch array, or the reduction can be used to speed up the switching speed of the display. Either is highly desirable, depending on the particular display application.

In accordance with embodiments of the present invention, a flexible layer that is not under tension may characterize this class of switch cells. Two representative cell embodiments, an LTC and an “S-cell” are shown in FIGS. 1 and 2, respectively. The LTC and the S-cell share several desirable qualities. For example, each cell may use electrostatic attraction between polymer foils that are maintained in close proximity. In this way, the magnitude of the electrostatic attraction force necessary to change the cell from one state to another is maximized. Also, the two cells have lower gas-elastic dampening, compared to other designs, allowing for faster switching times. Further, the cells designs relax manufacturing tolerances in terms of spacing between layers, substrate planarity, and cell pitch.

In the exemplary LTC shown in FIG. 1 (see general reference character 10), there are two sets of electrostatic plates. One set includes opposing plates 12 and 13 and the second set includes opposing plates 15 and 16. In this particular example, foil 11 may be the substrate foil and can be a relatively inflexible foil. On the other hand, foil 14 can be a movable foil. Also, foil 17 may be a secondary substrate foil. There may be no tension in foil 14 and, in some applications, foil 14 may have a degree of slack, for example.

In one embodiment, the length of material in foil 14 can exceed the dimensions of the cell by an amount sufficient to allow the electrostatic plates on both the substrate foils 11 and 17 to pull foil 14 out of contact with the opposing substrate layer. Typically, foil 14 may have a length that exceeds the length of the cell plus a fraction of the cell gap in length. The actual fractional amount may depend on the specific application and/or foil properties and will typically be determined on a case-by-case basis. Further, foil 14 may only be attached to support structures 20 and 21, which in turn can define the pitch of the call and/or pixel. Support structures 20 and 21 can extend in the Z-direction or perpendicular to the plane of the paper in FIG. 1. Also, foil 14 may be attached along only two edges within the cell. If desired, additional support structures may be provided along the length of a cell but in the particular example shown in FIG. 1, foil 14 is not attached or coupled to such additional supports. Of course, foils 11 and 17 may be attached or coupled to these additional support structures in some applications.

In operation of exemplary LTC 10 of FIG. 1, the motion of foil 14 may mimic a “zipping” action as power is alternatively applied to plates 12 and 13, and plates 15 and 16. This zipping action can ensure that the electrostatic force is relatively high because plates are maintained in relatively close proximity. This is advantageous because the same zipping action that caused LTC cell 10 to close its contacts to create an ON state, is also used to create the OFF condition. Further, this change in state from an ON state to an OFF state may occur relatively quickly because there is no gas to move out of the cell, there is no mechanical de-bounce time associated with a change in state, and the distance that must be traversed by foil 14 in changing states is minimized.

Since foil 14 may traverse from the substrate foil 11 to the secondary substrate foil 17 by electrostatic forces caused by the close proximity of the respective plate pairs (pair 12 and 13, and pair 15 and 16), this can also allow substrates 11 and 17 to be positioned with a relatively wide gap. The ability to increase the separation between substrate 11 and secondary substrate 17 can decrease the sensitivity of the design to manufacturing variations, provide wider manufacturing tolerances, and substantially eliminate design sensitivity to substrate flatness.

FIG. 2 shows a sectional side view of an exemplary S-cell (see general reference character 22) in accordance with embodiments of the present invention. The locations of electrostatic plates 12 and 13 (see FIG. 1), and contacts 23 and 24 (see FIG. 2), are substantially similar to corresponding locations in the exemplary LTC 10 design discussed above. However, in the particular example shown in FIG. 2, the movable foil may be disposed in an “S” shape between the cell confines (e.g., as defined by substrate foil 234 and secondary substrate foil 235). By locating electrostatic plates for the exemplary S-cell accordingly, the motion of the S-cell flexible foil may be substantially similar to that of foil 17 in the LTC 10 example discussed above. However, the S-cell flexible foil may be substantially displaced along reference axis 36 when switching between the ON and the OFF states.

Advantageously, the greater slack in the exemplary S-cell of FIG. 2 can afford a greater tolerance to manufacturing variability, as compared to other approaches. Further, in this particular S-cell example, contact 24 may not only be displaced from the surface of foil 234 in the OFF state, but may also assume a substantial angle relative to the base contact 23 on foil 234. Also, gas displacement in the switch during a switching transition can result in substantially reduced drag during a switching event.

In addition to drive circuitry for controlling the voltage applied to contacts 23 and 24, drive circuitry for controlling the voltage applied across plates 12, 13, 15 and 16 can be included in accordance with embodiments of the present invention. Drive circuitry for controlling plates 12 and 13 can operate in conjunction with drive circuitry for controlling plates 15 and 16 to actively pull foil 14 into the OFF state. Preferably, operation of the plate drive circuitry may be coordinated so that, as voltage is applied to contacts 12 and 13, voltage is simultaneously removed from contacts 23 and 24, and vice versa. However, if both sets of drive circuits are active at substantially the same time, tension can be applied to foil 14 to a desirable amount such that many of the manufacturing and environmental effects that could cause operation variations can be largely eliminated.

Thus, the operation of the exemplary LTC and S-cells may use substantially the same ON side drive scheme. For example, the OFF state may be driven by a separate circuit, but the drive voltage can be coordinated with the ON state drivers. The drive circuitry can electrostatically pull the cell into a desired state or otherwise regulate the tension in foil 14 during operation.

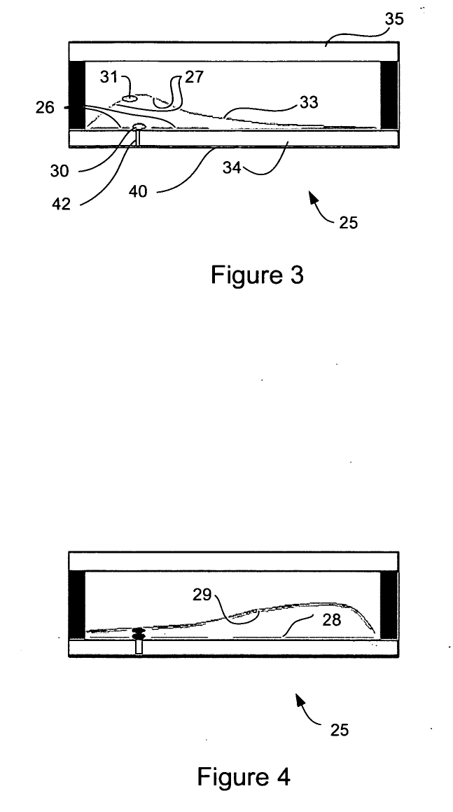

Referring now to FIGS. 3 and 4, a sectional side view of an exemplary wave cell in accordance with embodiments of the present invention is indicated by the general reference character 25. Substrate 34 may contain display power plate 40 on its front surface, and may be opposite secondary substrate 35. Power plate 40 can directly connect to a chosen display media, and may include various metals (e.g., Cu, Al, Ni, Ag, Au, and others) or metal sandwiches. Power plate 40 may also include conductive traces having conductive organic materials and/or metal loaded conductive ink materials, for example. A conductive via structure 42 may be formed between the front surface of substrate 34 and its back surface. This via structure can bring the electrical energy to the display media 40 from the switching contacts of the switch cell, for example.

Substrate 34 may also include an added electrostatic plate 26 that can latch the switch contacts 30 and 31 in an ON state. The side of movable foil 33 facing substrate 34 in this particular example can include one, two, or more electrostatic plates (e.g., plates 27) disposed across rows of the array. In accordance with embodiments of the present invention, a flexing of foil 33 can occur so that a bulge or “wave” is created in the foil as it changes state. In operation, display driver circuitry can activate the electrostatic plate on foil 33 and then either the ON or OFF electrostatic plate on substrate 34. The wave structure in foil 33 may traverse away from the opposing electrostatic plates that are attracting each other. Further, a latching plate structure can be incorporated into substrate 34.

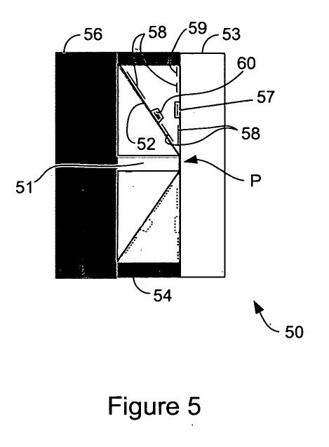

Yet another embodiment of a class of switch cells 50 is illustrated in the exemplary “pinch” cell structure of FIG. 5. In this particular example, column 51 can cause flexible layer 52 to come into intimate or near-intimate contact with substrate 53 and proximate to a fixed electrode. Advantageously, this example structure can minimize the amount of displaced gas volume caused by cell switching, thereby reducing the power needed to move the gas. By reducing such displaced gas volume, the time to switch between the ON and OFF states may also be reduced. Column 51 may further operate to increase the elastic modulus of the flexible layer 52, thereby improving manufacturability. Also, column 51 may divide a single switch cell, thereby allowing the same area to contain two active and independently controlled cells. A second set of electrical plates and contacts are shown in dashed form in FIG. 5. Column 51 can function to minimize any sensitivity to any deviations in the flatness of the substrate. A column 51 may be configured for each individual switch cell. Alternatively, column 51 may be replaced by a wall-like structure that spans more than one switch cell.

Switch cell 50 can include a five-layer structure having substrate 53, spacer layer 54, flexible layer 52, and secondary substrate 56. Column 51 can depress the flexible layer 52 in the middle of the cell area (e.g., at point “P”) until the flexible layer 52 is in close proximity or intimate or near-intimate contact with substrate 53. Substrate 53 may include an appropriately placed insulating layer so there is substantially no electrical contact of the driver plates on flexible layer 52 and substrate 53, respectively. Note that the spacing between driver plates is minimized at the contact point and therefore the electrostatic attraction between these plates may be very high for a selected voltage, as compared to if flexible layer 52 is maintained in a planar spaced-apart relationship relative to substrate 53. In this particular example, electrical contacts 57 may be located at a location away from the column contact point P. The exact electrical contact location is subject to engineering optimization on the basis of contact area, planarity, pull in voltage requirement, and other factors.

Substrate 53 can interface to display material by means of electrostatic or direct electrical contact. Substrate 53 may contain electrostatic plates 58, and optionally, another plate (e.g., latch plate 59), which can be used to make the backplane a bistatic switch. Plates 58 and 59 may be displaced from the close proximity to the mechanical contact point, as defined by the column 51.

A bridging contact 60 on flexible layer 52 may be located at a location that is remote from column 51. Flexible layer 52 may include perforations to allow for the displacement of trapped air inside of the cell. However, because of the “pinched” design, the absolute volume of air that needs to be displaced for a full switch function may be reduced to less than half, relative to a switch cell where column 51 is omitted. Such a reduction in volume of displaced air may have beneficial effects that can include: (i) the energy needed to displace the air may be correspondingly reduced by about half; and (ii) the speed with which the air can be displaced is increased, which means the switch can switch faster for a given drive voltage.

In accordance with embodiments of the present invention, scan voltages for the electrode plates (e.g., configured as row and column drivers), and the display/latch voltage may need to be defined based on the selection of properties of the flexible material, cell size, and spacing between substrate 53 and flexible layer 52 at the perimeter of the switch cell.

In operation, voltages may be presented to a pair of opposing driver plates. Because of the proximity of substrate 53 and flexible layer 52 at the mechanical contact point P, a substantial electrostatic attraction can pull substrate 53 and flexible layer 52 together at their narrowest point of contact. As the voltage on the scan plates is increased, a greater and greater area of contact between the foils may be created in response. Eventually, a large portion of the substrate 53 and flexible layer 52 may be in contact, held that way by electrostatic forces. During the process by which the foils are brought into contact, electrical switch contacts may also be brought into contact and can be used to power the display and latch the cell into a fixed ON state, for example.

By bringing the substrate 53 and flexible layer 52 into substantial proximity or intimate contact, the force available for electrostatic attraction may be thereby increased. Taking into consideration the effect of the dielectric (e.g., a 0.5 μm thickness of dielectric), a typical cell of about 1 cm extent could have an electrostatic force of 250 times that of an undeflected flexible layer 52 in the area of proximity point P. Since flexible layer 52 may already be in relatively close proximity, the electrostatic forces are relatively great and the ability of the cell to switch reliably may be significantly improved.

In one aspect of embodiments of the present invention, silicon-on-glass thin film transistors (TFT) based backplanes can be replaced with a matrix of MEM switches that are readily manufactured using inexpensive manufacturing equipment and printing process techniques. Further, in another aspect of embodiments of the present invention, the manufacture of scalable large optical displays on rigid or flexible plastic membranes at relatively low cost, but that have an adequate and useful lifetime, can be enabled. Further still, in another aspect of embodiments of the present invention, the manufacture of optical displays that may be flexed and/or twisted into novel shapes, while still substantially maintaining the display properties, can be enabled. Also, structures in accordance with embodiments of the present invention can be made by techniques, such as those commonly used in flexible printed-circuit board (f-PCB) manufacturing.

There are many existing products, and potentially a large number of new products, that can benefit from an array of switches laid out in matrix pattern. Such a matrix pattern can be sometimes uniform, and sometimes not, depending on the particular application. In accordance with embodiments of the present invention, the opened (or closed) switch can be utilized to activate a variety of devices suitable for applications so needing such a switch.

In accordance with embodiments of the present invention, the array switches may include one or more of the following attributes: (i) may be physically scaled depending on the application; (ii) may switch either AC or DC voltages; (iii) may switch either high or low voltages; (iv) may switch high or low current; and/or (v) may include either a momentary or latched switch. The most common need for such an array today is for flat panel displays to replace the relatively expensive backplane based on silicon transistors layered onto glass substrates.

It will further be appreciated that one or more of the elements depicted in the drawings/figures can also be implemented in a more separated or integrated manner, or even removed or rendered as inoperable in certain cases, as is useful in accordance with a particular application.

Although the invention has been described with respect to specific embodiments thereof, these embodiments are merely illustrative, and not restrictive of the invention. For example, although the invention has been discussed primarily with respect to a two-dimensional array, many other configurations or arrangements are possible. In other embodiments, it may be desirable to use other than row/column driver addressing; such as where a concentric circular arrangement is used, a random arrangement, etc. A configuration can be multi-dimensional, as where two or more cells are stacked vertically so that a pixel can be defined by multiple (e.g., red, green and blue) independent display elements. Naturally, in such a stacked configuration the cells on top should be transmissive to light emitted or reflected by underlying cells.

Although the invention has been discussed with respect to a display system, other applications are possible. For example, the array of cells can be applied with electrostatic fields by laser, electron beam or other particle or energy beam, pressure, etc., similar to technologies used in imaging systems (e.g., copiers, charge coupled devices, dosimeter, etc.) or other systems. In such an application, the driver circuitry can be replaced with sensing circuitry to detect whether a cell is in an open or closed position. Thus, a sensing array can be achieved. Embodiments may include various display architectures, biometric sensors, pressure sensors, temperature sensors, light sensors, chemical sensors, X-ray and other electromagnetic sensors, amplifiers, gate arrays, other logic circuits, printers and memory circuits.

Functionality similar to that discussed herein may be obtained with different configurations and arrangements, sizes or combinations of components. Use of the term microelectromechanical (MEM) is not intended to limit the invention. Embodiments may use components of larger or smaller size than those described herein. In other designs, components may be omitted or added. For example, additional contact pads on either the non-pliable or flexible membranes can be added. A different contact arrangement may also allow for only two contact surfaces rather than the three described herein. In other embodiments, both membranes may be made flexible. Other variations are possible.

Other types of force than electrostatic may be used to bring membranes into proximity. For example, electromagnetic, applied pressure (e.g., atmospheric or gaseous, liquid, solid), gravitational or inertial, or other forces can be used. Rather than use a force to bring two membranes into proximity, another embodiment can have an un-energized state of membranes in proximity (i.e., a closed switch state) and can use a force to cause the membranes to be brought out of proximity (i.e., an open switch state). For example, an electrostatic force can be used to cause the membranes to repel each other and break a contact connection.

Any signal arrows in the drawings/Figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a,” “an,” and “the” includes plural references unless the context clearly dictates otherwise. Also, as used in the description herein and throughout the claims that follow, the meaning of “in” includes “in” and “on” unless the context clearly dictates otherwise.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims.

What is claimed is:

1. In an array of microelectromechanical switch cells, each said switch cell comprising:
a substrate having at least one substrate drive plate and a contact electrode; and
a flexible foil maintained in a spaced apart relationship relative to said substrate such that said flexible foil is maintained at an angle relative to said substrate, said flexible foil having at least one drive plate opposing said substrate drive plate such that said drive plate and said substrate drive plate are positioned on a part of said flexible foil and said substrate, respectively, that has a less than maximum separation between said substrate and said flexible foil.

2. The switch cell of claim 1, further comprising a secondary substrate such that said flexible foil is positioned between said substrate and said secondary substrate, said secondary substrate being positioned substantially parallel to said substrate.

3. The switch cell of claim 2, further comprising least one pair of opposing drive OFF plates, one of which is positioned on said flexible foil and one of which is positioned on said secondary substrate.

4. The switch cell of claim 3, wherein said pair of opposing drive OFF plates are operated in conjunction with said substrate drive plate to alternatively switch said switch cell between an ON state and an OFF state.

5. The switch cell of claim 3, wherein said pair of opposing drive OFF plates are positioned on a part of said foil and said secondary substrate that has a less than maximum separation between said substrate and flexible foil.

6. The switch cell of claim 4, wherein said drive plates are operated to maintain said flexible foil in a biased state between an ON state and an OFF state.

7. In an array of microelectromechanical switch cells, each said switch cell comprising:
a substrate having a first substrate drive plate and a contact electrode; and
a flexible foil maintained in a spaced apart relationship relative to said substrate such that said flexible foil is disposed in an “S” shape, said flexible foil having at least one drive plate opposing said substrate drive plate such that said drive plate and said substrate drive plate are positioned on a part of said flexible foil and said substrate, respectively, that has a less than maximum separation between said substrate and said flexible foil.

8. The switch cell of claim 7, further comprising a secondary substrate such that said flexible foil is positioned between said substrate and said secondary substrate, said secondary substrate being positioned substantially parallel to said substrate.

9. The switch cell of claim 8, further comprising a second pair of opposing drive plates, one of which is positioned on said flexible foil and one of which is positioned on said substrate spaced apart from said first substrate drive plate.

10. The switch cell of claim 9, wherein said drive plates- are configured to be operated to alternatively switch said switch cell between an ON state and an OFF state.

11. The switch cell of claim 10, wherein said drive plates are operated to maintain said flexible foil in a biased state between an ON state and an OFF state.

12. In an array of microelectromechanical switch cells, each said switch cell comprising:
a substrate having at least one substrate drive plate and a substrate contact electrode; and
a flexible foil coupled to said substrate at substantially first and second ends, said flexible foil having a foil contact electrode and at least one drive plate opposing said substrate drive plate, said flexible foil being configured to have a position of a maximum spacing along said flexible foil relative to said substrate change in response to an operation of said drive plate and said substrate drive plate.

13. The switch cell of claim 12, further comprising a secondary substrate such that said flexible foil is positioned substantially between said substrate and said secondary substrate, said secondary substrate being positioned substantially parallel to said substrate.

14. The switch cell of claim 13, further comprising at least one pair of opposing drive OFF plates, one of which is positioned on said flexible foil and one of which is positioned on said secondary substrate.

15. The switch cell of claim 14, wherein said pair of opposing drive OFF plates are operated in conjunction with said substrate drive plate to alternatively switch said switch cell between an ON state and an OFF state.

16. The switch cell of claim 15, wherein said foil contact electrode and said substrate contact electrode are configured to be in substantial proximity when said switch cell is in an ON state.

17. The switch cell of claim 15, wherein said drive plates are operated to maintain said flexible foil in a biased state between an ON state and an OFF state.

18. In an array of microelectromechanical switch cells, each said switch cell comprising:
a substrate having a first substrate drive plate and a contact electrode;
a flexible foil maintained in a spaced apart relationship relative to said substrate;
a secondary substrate maintained in a spaced apart relationship with respect to said substrate such that said flexible foil is maintained between said substrate and said secondary substrate; and
a structure, coupled to said secondary substrate, for positioning a portion of said flexible foil proximate to said substrate.

19. The switch cell of claim 18, wherein said structure is configured to define at least two sub-pixels.

20. The switch cell of claim 18, further comprising at least a pair of opposing drive plates, one of which is positioned on said flexible foil and one of which is positioned on said substrate spaced apart from said structure.

21. The switch cell of claim 20, further comprising at least a pair of opposing drive plates positioned on said flexible foil, one of which is positioned on said substrate spaced apart from said structure and adapted to switch said switch cell to an OFF state.

22. The switch cell of claim 21, wherein said drive plates are configured to be operated to alternatively switch said switch cell between an ON state and an OFF state.

23. The switch cell of claim 22, wherein said drive plates are operated to maintain said flexible foil in a biased state between an ON state and an OFF state.
